(19) United States
(12) Patent Application Publication
(10) Pub. No.: US 2007/0198727 A1
(43) Pub. Date: Aug. 23, 2007

(54) Method, apparatus and system for extracting field-specific structured data from the web using sample

(76) Inventor: Tao Guan, Acton, MA (US)

Correspondence Address: Mark S. Leonardo, Esq.;Brown Rudnick Berlack Israels LLP, One Financial Center, Boston, MA, 02111, US

(21) Appl. No.: 11/582,816

(22) Filed: Oct. 18, 2006

(30) Foreign Application Priority Data
Oct. 20, 2005 (CN) 200510109288.7

(51) Int. Cl. G06F 15/16

(52) U.S. Cl. 709/228; 709/201

(57) ABSTRACT

A computer method, apparatus and system is presented to extract field-specific structured data from the World Wide Web using a sample. The method includes: collecting a sample automatically or by a user supervision that records how the user visits the data; analyzing the sample using a field-specific knowledge base to extract a pattern of the sample; extracting data which crawls webpages using a path, and extracting data that matches the pattern; integrating the data by removing duplicates, adding a missing value, and converting obtained data into a unified format so that the data from a different website can be integrated as one data set. The system can extract Web data with a similar structure from multiple websites automatically using a sample.

### CROSS-REFERENCE TO RELATED APPLICATIONS

This application claims the benefit of Chinese Application No. 200510109288.7 filed with the State Intellectual Property Office of the Peoples Republic of China on Oct. 20, 2005.

### BACKGROUND

1. Technical Field

This invention relates generally to a method and system for retrieving information, extracting data, and integrating data from the World Wide Web. More particularly, the invention relates to a method, an apparatus and a system for an extraction and an integration of structured data from HTML pages.

2. Description of the Related Art

Web data extraction is a technique used to extract semi-structured or structured data. The data is extracted from a webpage written in HTML, and transformed into XML or another format (e.g. CSV or relational database) so that it could be used by other applications. As the Internet is growing, more and more information is available through the Web. One special kind of data is structured data. For example, structured data can be illustrated as data regarding a job opening. For example, job openings include, but are not limited to, a job title, a location, a posted date, and a salary. Structured data may be hidden data (or deep data) which can only be returned in a dynamic page in response to a submitted query (e.g. search job through job boards or newspapers). Although the data is visible to human beings through a Web browser, the extraction and integration of such kinds of data is still a challenge because data represented in an HTML webpage is in text format, and there is no semantic tag, which is what is used in an XML format for computers or applications to recognize useful data (e.g. job title).

There are many tools and systems developed for Web data extraction, including but not limited to (1) Wrapper programming languages or tools; and (2) Machine learning/supervised wrapper generation.

Wrapper is an application which may crawl a website to collect a webpage(s) or extract data from a webpage(s). There are several wrapper programming languages or tools which help in the development of a site-specific wrapper to extract structured data from the site. One advantage of the wrapper programming language is that data quality is precise. However, the major disadvantage is inefficiency. Wrapper works efficiently if one is extracting data from hundreds of websites, but Wrapper becomes inefficient when data is being extracted from thousands or millions of websites.

Machine learning/supervised wrapper generation may generate wrappers automatically or semi-automatically, which is efficient, but results may be unsatisfactory. It is an active topic for theoretical and experimental research, but rarely used in practice. In addition, machine learning/supervised wrapper generation may need a large number of webpages or samples for training or learning, which is tedious and time-consuming.

U.S. Patent Application No. 20050022115 presents a visual and interactive wrapper generation using a user-specified sample. However, the sample is described only by a pattern which is obtained by generalizing a location descriptor, called a plain tree path, in an example-document. It is defined by HTML tags, sequence or another logical condition. There is no path (how to access the sample from website URL) specified. In addition, it is therefore hard to handle deep data which URL and content may be updated everyday, e.g. job listing.

U.S. Pat. No. 6,195,679 provides an Internet browser session navigation and recording system. It allows a user to review, edit and repeat their Web browsing history. It is not used for data extraction, and no automation using knowledge base is disclosed.

China Patent No. CN1410918 presents a data extraction method by collecting data from a search engine like Google, using a machine learning approach. A set of sample pages needs to be collected and pre-processed manually. The system is trained to generate rules of data extraction from the sample pages, and then applies rules to other webpages. The technique of natural language processing is also applied, for example, syntax analysis and semantic analysis.

China Patent No. 1255680 discloses an online shopping system which may collect and compare prices automatically. The system uses robots to simulate humans to read HTML files from online stores and to extract price information from the files. The system cannot work in any other fields, like job openings.

### SUMMARY OF THE INVENTION

The present invention discloses a computer method and system which can extract field-specific structured data from the World Wide Web using a user-specified sample. The steps include: collecting a sample either automatically or by a user supervision that records how the user visits the data; analyzing the sample using a field-specific knowledge base to extract a pattern from the sample; extracting a second data by crawling webpages using a path, and extracting the second data that matches the pattern; integrating data which removes duplicates, adding a missing value, and converting obtained data into a unified format so that the second data from a different website can be integrated as one data set. The system can extract Web data with similar structures from multiple websites automatically, using only a sample. The data quality and efficiency is better than other techniques in this area.

The system used to implement the method is comprised of four modules and a knowledge base.

One module is a sample collection module. The sample collection module is a visual tool which may help a user specify a sample. When a URL is input into the system, the system may find a path of the sample automatically using domain knowledge from a knowledge base. If the system fails to automatically find a path of the sample, a Web browser is initiated to allow the user to guide the system to find the sample. The path of the sample contains a sequence of URLs and user actions when a Web browser is used. For example, user actions include the user clicking a link, inputting text or clicking a button.

Another module is a sample analysis module. The sample analysis module analyzes the sample to extract a pattern of the sample using the knowledge base. The pattern is a sequence of HTML tags, font types, font sizes, and a location of HTML corresponding elements in a DHTML page.

Another module is a data extraction module. The data extraction module extracts data from a webpage which matches the path and the pattern obtained from the sample.

Another module is a data integration module. The data integration module removes duplicate data, adds missing values by default or user pre-defined values, and transforms data into an XML format or stores them in a relational database.

In addition, a domain-specific knowledge base is used for automation of sample collection and analysis.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 shows a user interface for sample collection, analysis and data extraction;

FIG. 2 shows a block diagram of system architecture;

FIG. 3 shows a block diagram of workflow of the invention;

FIG. 4 shows a block diagram of a workflow on sample collection and analysis;

FIG. 5 shows a block diagram of a workflow on data extraction; and

FIG. 6 shows a block diagram of an example of the invention.

### DETAIL DESCRIPTION OF THE INVENTION

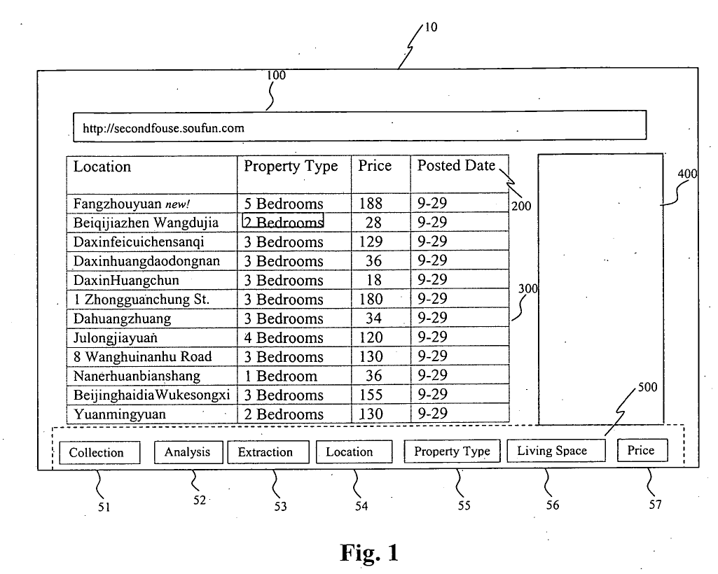

Turning now to the figures, wherein like components are designated by like reference numerals throughout the several views. Referring initially to FIG. 1, an exemplary embodiment of a user interface of the present invention is shown. In this example, data will be extracted and integrated regarding house for sale information from several websites. The interface comprises a URL input area 100, a data title area 200, a display window 300, a user input area 400, and a button area 500. Here, the button area 500 contains at least one generic button. In this particular embodiment, the button area 500 includes a collection button 51, an analysis button 52, and an extraction button 53. In addition, this example includes some domain-specific buttons including a location button 54, a property type button 55, a living space button 56, and a price button 57.

The generic buttons, collection 51, analysis 52, and extraction 53, are generally common buttons. Collection button 51 is used for collecting a sample, which can be done in several ways. One way is automatic. Another way is by user supervision, where user actions on a Web browser are recorded as a path of a sample. The analysis button 52 is used for processing a sample analysis. The analysis button may extract the pattern of the sample shown in display window 300. The extraction button 53 is for extracting and integrating data from the website, removing any duplicates, adding any missing value, and transforming the data into an XML format or storing the data in a database.

The button location 54, property type 55, living space 56, and price 57 are optional buttons designed for user convenience.

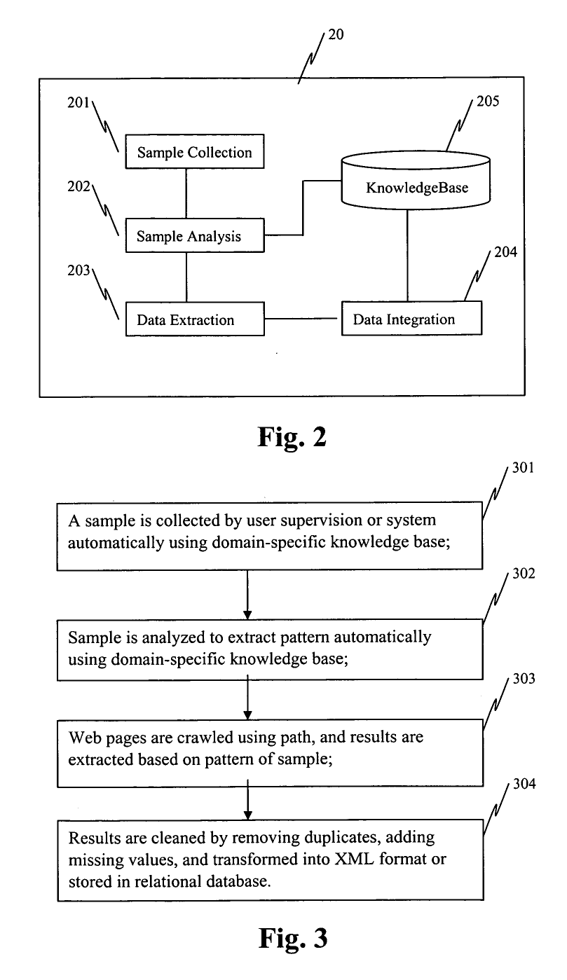

FIG. 2 is a block diagram of the system architecture. The system comprises of four modules: a sample collection module 201, a sample analysis module 202, a data extraction module 203, a data integration module 204, and a domain-specific knowledge base 205.

The sample collection module 201 is a visual tool that can help a user specify a sample. When a website URL is input, the system may find a path of the sample automatically using the knowledge base 205. If the knowledge base 205 fails to find a path of the sample, a Web browser is initiated to allow the user to guide the system to find the sample. The path of the sample contains a sequence of URLs and user actions when using the browser. Examples of the user actions include clicking a link, inputting text, and clicking a button.

The sample analysis module 202 analyzes the sample to extract the path and the pattern using the knowledge base 205. The pattern includes but is not limited to a sequence of HTML tags, font types, font sizes, and a location of HTML corresponding elements in a DHTML page.

The data extraction module 203 calls an HTTP protocol or drives a Web browser to crawl pages from websites, and extracts the data which matches the path and the pattern of the sample. The data integration module 204 removes duplicate data, adds any missing values by default or user pre-defined values, and transforms data into an XML format or stores them in a database.

FIG. 3 is a block diagram illustrating a method of the present invention. At step 301, a sample is collected by a user automatically by a system using a domain-specific knowledge base. At step 302, the sample is analyzed to extract a pattern automatically using the domain-specific knowledge base. At step 303, an HTTP protocol or Web browser is used to crawl a webpage from a website using a path, and results are extracted based on the pattern of the sample. And, at Step 304, the data is cleaned by removing any duplicates, adding missing values, and by transforming the data into an XML format or storing the data in a relational database.

A knowledge base is a common technology used in many applications. For example, Word Net (http://wordnet.princeton.edu) is a knowledge base developed at Princeton University and used widely in many machine learning or automation systems. The domain-specific knowledge base 205 used in the present application is a knowledge base that may include domain-specific rules. For example, “XXX County” is a location; “[0-9]*, XXX Street” is an address; “XX Bedrooms” is a property type; and “Location, Property Type, Living Space, Price, Address, Posted Date” is a house for sale record.

Rules in general are used by the system automatically to find a sample and analyze the pattern.

There are several methods for the system to find a sample. One way is by user supervision. A second way is automatic using a knowledge base. The example shown in FIG. 1 is used to explain the methods.

For example, under the user supervision method, an entry URL is input in a URL Input Area 100. For example, http://secondhouse.soufun.com. A specified webpage loads into a display window 300, a user may move the pointer to a field, and click on it, for example, “2 Bedrooms” on the second line in the display window 300. The user may input “Property Type” at a User Input Area 400 or click button Property Type to allow system to know that “2 Bedrooms” is a sample of property type.

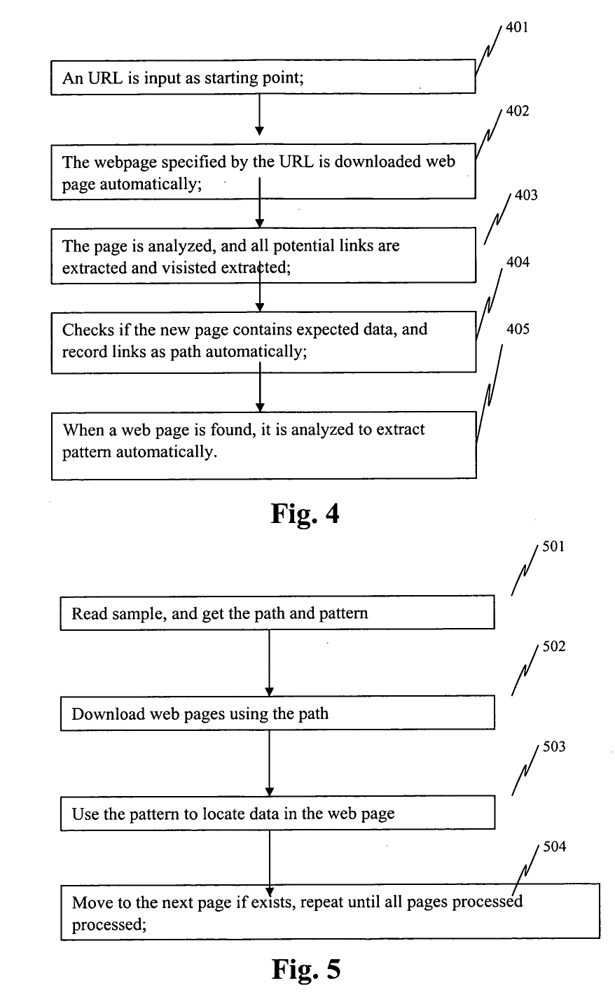

For example, under the automatic (using a knowledge base) method, the steps of an embodiment of the automatic sample collection and are shown in FIG. 4.

At step 401, an URL (e.g. http://www.soufun.com) is input to a URL input area 100. At step 402, the webpage is downloaded automatically into the display window 300. At step 403, the webpage is analyzed and all links are extracted from the page. The knowledge base 205 is called to evaluate these links, and then ranks them by relevance with information. At least one link will be chosen, and the Web browser is navigated to the link automatically. At step 404, the new webpage is checked for containing any expected data. If there is expected data, the link chosen in the last step of a path is recorded. If there is no expected data, the system returns back to the last page, and the next link is tried. If all links are tested, but no data is found, the user supervision method is started. The user may visit data manually, and the system automatically records the user actions as the path. At step 405, when a webpage containing a sample is found, the system analyzes the webpage in a display window 300 to extract the pattern automatically.

An example of a method of a page analysis is shown by example on the sixth line of the page shown in FIG. 1. The sixth line comprises of “1 Zhongguanchung St. 3 Bedrooms 180 9-29”. Using knowledge base 205, the following may be induced: “1 Zhongguanchung St.” is an address; “3 Bedrooms” is a property type; “180” is an unknown, it may be a price or a living space; and “9-29” is a posted date.

In addition, there may be a rule stating that a House for Sale Record includes: Location, Property Type, Living Space, Price, Address, and Posted Date.

The system would know that the sixth line of FIG. 1 is likely a House For Sale record because it contains an address, a property type, a price and/or living space and a posted date. When the rest of the lines are analyzed, if most lines have a similar structure, the system may use the page to generate a sample.

In a case that the system cannot recognize the data correctly, for example, what the number “180”. means, the user supervision method can be involved. The user may highlight the number 180, and click button Price 57 or input the word “price” in User Input Area 400.

When a page containing the sample is found, analysis extracts the pattern of the sample from the page. For example, the source code (HTML file) of the page shown in display window 300 includes several items. Referring to FIG. 1, line 6, includes the phrase “1 Zhongguanchung St.” which is shown in the first column of the third table in the code. For example, the HTML tag before it is <A heof= . . . target=”_Blank”>, and the tag after it is </FONT>. The font color is #FFF000. The phrase “3 Bedrooms” is shown in the second column, labeled “Property Type”, of the third table in the code in FIG. 1. For example, the tag before it is <TD class=“style14”>, and the tag after it is </TD>.

While the analysis is repeated on each line in a webpage, and all have a similar pattern, position, and other properties, the following data structure can be used to describe the sample:

```
<URL>http://www.soufun.com</URL>
<LINK>old house</LINK>
<URL>http://secondhouse.soufun.com</URL>
<ITEM><NAME>Address</NAME>
  <POSITION><TABLE>3</TABLE><COLUMN>1</COLUMN></PO
  SITION>
  <COLOR>#fff000</COLOR><PREVTAG>.........</PREVTAG>
</ITEM>
```

FIG. 5 is a block diagram of a workflow on a data extraction. When the user interface in FIG. 1 is displayed, data extraction can be started by clicking button extraction 53 or by running a batch job from Microsoft DOS Window. Step 501 includes reading the sample and getting the path and the pattern. At step 502, the webpages using the path are downloaded. At step 503, the pattern is used to locate data in the webpage. Step 504 includes moving to the next page if one exists, repeating steps 501-503 until all pages are processed. If the data extraction is run from a batch job, a DOS window is opened. The command “EXTRACT” is used to start the process.

Data integration is discussed using the example shown in FIG. 1. Invalid data or duplicate data is removed. Data extracted from webpages, may not be valid. For example, the data title 200, “Location Property Type Price Posted Date”, may not valid. This line matches the pattern of the sample in terms of a color, a position, and tags, but it is not a real house for sale record. When the knowledge base is checked, “Property Type” is identified to be in a format such as “X Bedrooms”. The line 200 does not match it, and thus would be removed from the result set.

Sometimes, a missing value is also added. For example, the posted date in Display Window is “9-29” should be normalized as “2005-09-29” otherwise it may not be integrated with data from other websites. Date format are usually formatted as “YYYY-MM-DD”.

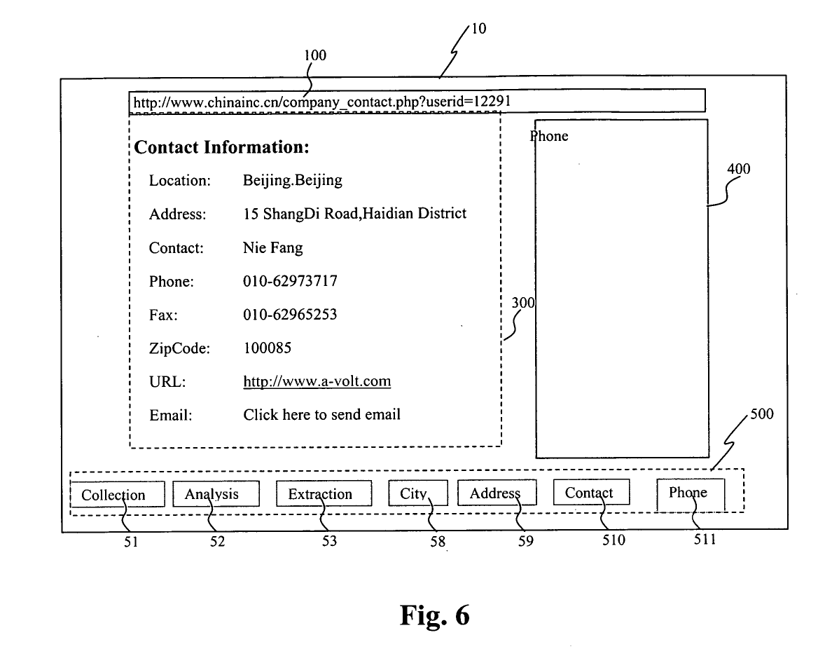

FIG. 6 is another example used to explain this invention. FIG. 6 extracts company contact information from website http://www.chinainc.com.

If user supervision is applied, user may input the URL into a URL input area 100. A webpage is shown in a display window 300 when it has downloaded. In this example, “Beijing” is highlighted and button City 58 is clicked. In this example, “15 Shangdi Road, Haidian District” is highlighted and button Address 59 is clicked. Also, in this example, “Nie Fang” is highlighted and button Contact 510 is clicked. Also, in this example, “010-62973717” is highlighted and button Phone 511 is clicked. For example, if automation is applied, an entry URL of the website needs to be input, http://www.chinainc.cn.

The system looks for a webpage containing relevant information automatically by calling the knowledge base 205 to categorize webpages based on keywords, for example, but not limited to, contact, phone, fax, name, and zip code.

If an automatic search fails, a Web browser may allow a user to drive it to a page containing a sample. The system will record user navigation automatically, and use this information as the path of sample.

For example, as shown in FIG. 6, when a webpage is loaded, the rules in the knowledge base 205 are used to locate target data. For example, address is “15 ShangDi Street, Haidian District”; Phone is 010-62973717; Fax is 010-62965253; Zip code is 100085; and URL is “http:www.a-volt.com”.

In some instances, the system may not be able to recognize the data items accurately. For example, the system may not know the difference between the phone number “010-62973717” and the fax number “010-62965253” in Display Window 300. In this particular example, user supervision would be needed. For example, when “010-62973717” is highlighted, the user may click button phone 511 or user type “phone” into user input area 400 to allow system to know that one particular number input is a phone number and not a fax number.

In FIG. 6, the buttons city 58, address 59, contact 510, and phone 511 are optional buttons. One example of a use for the city button 58 is to help the system recognize “city” in situations when the system cannot identify it automatically. Buttons address 59 and contact 510 can also be used for address and contact persons, respectively.

When a webpage containing samples is located, it needs to be analyzed to extract a pattern. A position in the source code of an HTML file is extracted. The example shown in display window 300 is located in the seventh table, where city is the first column, address is the second column, and contact is the third column. The color #FFFFFF, the previous tag<TD> and next tag </TD> are recorded. The information is used as a pattern.

In addition, the path to the webpage (collected in the sample collection) comprises of:

<URL>http://www.chinainc.cn</URL>

<LINK>Company List</LINK>
<LINK>Beijing</LINK><LOOP>YES</LOOP>

<LINK>Beijing Anfu Electricity Limited</LINK><LOOP>YES</LOOP>
<LINK>Contact</LINK>.

For example, here, <LOOP>YES</LOOP> means that all links similar to the <LINK>Beijing</LINK> needs to be checked, for example, “Shanghai”□“Tianjing”□“Chongqin” etc.

When a path and a pattern of a sample are obtained, webpages following the path will be downloaded, and the pattern is used to extract data from the pages. If the path containing <LOOP>YES</LOOP>, not only the link (e.g. in above example) is accessed, but also other links similar to it will be visited. Thus, the contact information for all companies will be extracted.

If there is an invalid data or a duplicate data, that data will be removed. The missing values like “company category (industry)” may show up in other pages. It is not extracted in this example.

The present invention discloses a method and a system of extracting domain-specific structured data from the World Wide Web using a sample. The system can extract Web data with similar structures from multiple websites automatically by only using a sample. The data quality and efficiency is much better than other techniques in this area.

It is to be understood that the specific embodiments of the invention that have been described are merely illustrative of certain applications of the principles of the present invention. Numerous modifications may be made to sample a description and a data extraction method described herein without departing from the spirit and scope of the present invention. Further, the invention is not limited by the examples shown in the embodiment.

What is claimed is:

1. A method for extracting a field-specific structured data from the World Wide Web using a sample comprising:
collecting a sample, either automatically or by a user supervision which records how a user visits said data;
analyzing said sample, using a domain-specific knowledge base to extract a pattern of said sample;
extracting said data by crawling webpages using a path, and extracting said data that matches said pattern; and
integrating said data by removing a duplicate, adding a missing value, and converting a result into a unified format so that said data from a different website can be integrated as one data set.

2. The method of claim 1, wherein a sample is collected automatically using a knowledge base or from a user supervision based on how a user uses a Web browser to visit said data.

3. The method of claim 2, wherein the steps of said user supervision include:
using a Web browser to locate said data, and recording on a system said user actions automatically as a path of said sample.

4. The method of claim 1, wherein the steps of said data extraction include:
reading said sample including said path and said pattern;
downloading webpages using said path;
extracting said pattern data that matches said pattern; and
moving to an other page if said other page exists, and
repeating said extracting step until all pages are crawled.

5. The method of claim 1, wherein said path of said sample includes starting URL, and user actions, and wherein said pattern of said sample includes at least one sequence of an HTML tag, a font type, a font size or a position of an HTML corresponding element in a webpage.

6. The method of claim 1, wherein the steps of integrating said data include:
removing duplicates;
adding a missing value using a default or a user pre-defined value;
transforming said data into a unified structure; and
storing said data in an XML file or a relational database.

7. A system of extracting field-specific structured data from the World Wide Web using a sample comprising:
a sample collection module for obtaining a sample automatically or by a user which records how said user visits said data;
a sample analysis module for analyzing said sample using a domain-specific knowledge base to extract a pattern of said sample;
a data extraction module for crawling at least one webpage using a path, and for extracting said data that matches said pattern; and
a data integration module for removing a duplicate, for adding a missing value, and for converting a result into a unified format so that said data from a different website can be integrated as one data set.

8. The system of claim 7, wherein a sample is collected automatically using a knowledge base or from a user supervision based on how said user uses Web browser to visit said data.

9. The system of claim 7, wherein the steps of said user supervision includes:
using a Web browser to locate said data, and
recording said user actions automatically as said path of said sample.
